(19) United States
(12) Patent Application Publication
(10) Pub. No.: US 2003/0141320 A1
(43) Pub. Date: Jul. 31, 2003

(54) Horizontal container with a moveable bulkhead follower for the storage and transport of bulk viscous material

(75) Inventor: Clarence B. Coleman, Oakland, CA (US)

Correspondence Address: JAMES R. CYPHER, 405 14TH STREET, SUITE 1607, OAKLAND, CA, 94612

(73) Assignee: CSI Fabricated Metal Bins, Inc.

(21) Appl. No.: 10/377,506

(22) Filed: Feb. 28, 2003

Related U.S. Application Data
(63) Continuation of application No. 09/815,627, filed on Mar. 23, 2001, now abandoned.

(51) Int. Cl. B67D 5/42

(52) U.S. Cl. 222/386

(57) ABSTRACT

A horizontal bulk material container has a cylindrical shell having a horizontal axis. Disposed within the shell intermediate the end walls thereof is a bulkhead follower. In one embodiment, a manhole is located at each end of the shell to provide access to the shell. The bulkhead follower has a cylindrical cross-sectional area slightly less in diameter than the diameter of the cylindrical cross-sectional area of the shell. The forward end surface of the bulkhead follower has a convex configuration conforming to the concave contour of the forward end wall of the shell.

Mounted circumferentially on the bulkhead follower are a stiffener ring, bearings, spacers and wiper/seals. In one embodiment, the sides of the flexible wiper/seals alternately wipe the inner wall of the shell in a continuous manner dependent on the direction of travel of the bulkhead follower. Bulk material is discharged into the shell between the convex end wall of the bulkhead follower and the confronting concave forward wall of the shell through suitable fittings. Air under pressure is applied to the rear surface of the bulkhead follower to move the bulkhead follower toward the forward end wall of the shell to discharge the bulk material from the shell through suitable fittings.

This application is a continuation of U.S. patent application Ser. No. 09/815,627, filed Mar. 23, 2001. U.S. patent application Ser. No. 09/815,627 is hereby incorporated herein by reference.

### BACKGROUND OF THE INVENTION

The present invention relates in general to bulk material containers and, more particularly, to a horizontal bulk material container with a movable bulkhead follower.

In the patent to Berry, U.S. Pat. No. 3,828,988, issued on Aug. 13, 1974, for Tank For Bulk Transport And Storage Of Semisolid Materials, there is disclosed a horizontal tank for the transport and for the storage in bulk of semisolid material. The tank has a piston movable by compressed air longitudinally within the tank. The piston is forced toward an outlet of the tank to discharge semisolid bulk material. Flexible seals extending beyond the periphery of the piston scrape semisolid material from the inner wall of the tank and seal the space between the piston and the tank. Circumferential rows of ball rollers extend around the periphery of the piston and are spaced longitudinally from one another on the piston. The balls are resiliently mounted on the piston to prevent canting of the piston in the tank. Each tank head includes a removable cover for providing access to the interior of the tank.

The patent to Watson, U.S. Pat. No. 4,721,235, granted on Jan. 26, 1988, for Tank For Transport And Storage Of Semisolid and Fluid Materials, discloses an elongated tank for the transport and for the storage in bulk of semisolid and fluid materials. The tank has an outlet at one end thereof for the material contained therein to be discharged. A cylindrical piston is disposed in the tank and is moved in the direction of the outlet for forcing material in the tank to be discharged through the outlet. An elastic annular seal is carried in a circumferential channel around the piston adjacent one end of the piston. When the piston slides in the tank, the seal is maintained in sliding engagement with the inner wall of the tank to wipe material from the inner wall of the tank and to seal the space between the piston and the tank. The piston is held against canting in the tank by a plurality of pads.

The patent to Watson U.S. Pat. No. 5,114,054, granted on May 19, 1992, for Tank Piston With Teflon Sheathed Packing Member discloses an elongated cylindrical tank for the transport and the storage in bulk of semisolid and fluid materials. The tank includes an outlet at one end thereof. A cylindrical piston is disposed in the tank and moves toward the outlet of the tank to discharge the semisolid and fluid materials from the tank. A seal is provided to seal the space between the piston and the inner wall of the tank. The seal comprises an elastic annular packing. A circumferential flexible sheath overlies the packing for protecting the packing. The packing is expanded by air pressure for pressing against the inner wall of the tank to wipe material from the inner wall of the tank and to seal the space between the piston and the tank. The head of the piston is configured for complementary engagement with the interior contour of the forward end of the tank so that the contained material may be efficiently and completely forced through the outlet of the tank. The piston includes a plurality of nylon pads extending radially outward from the periphery of the piston for engagement with the inner wall of the tank to hold the piston body against canting in the tank. In the patent to Watson, U.S. Pat. No. 5,746,112, granted on May 5, 1998, for Piston For Tank, there is disclosed an elongated tank for the transport and storage in bulk of semisolid and fluid material, such as grease and oil. The tank has an outlet at one end thereof for discharging material contained therein. A cylindrical piston is sized to slide in the tank for moving in the direction toward the outlet thereof to force the material in the tank through the outlet. The piston caries an annual elastic seal. The seal has an annular crown projecting radially outward from the piston and is engageable with the interior surface of the tank.

In the patent to Coleman, U.S. Pat. No. 4,552,090, granted on Nov. 12, 1985, for Bulk Material Container With A Rigid Follower, there is disclosed a bulk material container comprising a shell. Disposed within the shell is a floatable rigid follower. The vertical position of the floatable rigid follower varies with the level of flowable bulk material stored in the shell. The rigid follower comprises axially aligned, juxtaposed rigid sections with an annular flexible wiper secured therebetween. The flexible wiper cleans the inner wall of the shell during the movement of the rigid follower. In a modification of the bulk material container, the wiper is replaced by an annular inflatable seal.

### SUMMARY OF THE INVENTION

An object of the present invention is a provide a horizontal bulk material container with a movable bulkhead follower wherein the sides of a flexible, annular wiper/seal mounted circumferentially on the bulkhead follower alternately wipe the inner wall of a shell of the horizontal container dependent on the direction of travel of the bulkhead follower.

Another object of the present invention is to provide a horizontal bulk material container with a movable bulkhead follower wherein a stiffener ring and bearings mounted circumferentially on the bulkhead follower along with an annular spider control the cylindrical configuration of the rear end of the movable bulkhead follower and uniformly distribute the forces applied thereto resulting from any bending or distortion of the bulkhead follower in its travel.

Another object of the present invention is to provide a horizontal bulk material container having a sight gauge for indicating the location of a movable bulkhead follower within a shell of the horizontal bulk material container.

Another object of the present invention is to provide a horizontal bulk material container in which a shell of the horizontal container is heated externally to reduce temperature changes in the product contained in the shell. With many of the materials for which the container of the present invention is intended to be used as a transport, if the temperature of the material drops below a thresh-hold temperature, the material will become more viscous and difficult to unload.

Another object of the present invention is to provide a horizontal bulk material container in which a shell of the horizontal container is heated externally to reduce temperature changes of the shell for maintaining a uniform cross-sectional configuration of the shell.

Another object of the present invention is to provide a horizontal bulk material container which the wiper/seals of the follower are mounted on fasteners disposed parallel to the longitudinal axis of the follower.

Briefly described, the horizontal bulk material container of the present invention comprises a cylindrical shell having a horizontal axis. Disposed within the shell intermediate the end walls thereof is a bulkhead follower. Preferably, the axis of the bulkhead follower is substantially coincident with the axis of the shell. Preferably, a manhole is located at each end of the shell to provide access to the shell. Each manhole has a manhole cover. The bulkhead follower has a cylindrical cross-sectional area slightly less in diameter than the diameter of the cylindrical cross-sectional area of the shell. The forward surface of the bulkhead follower has a convex configuration conforming to the concave contour of the facing forward wall of the shell. The rear surface of the bulkhead follower has a concave configuration.

In the preferred embodiment, mounted circumferentially on the bulkhead follower are at least one stiffener ring, and a plurality of bearings, spacers and flexible wiper/seals. In one preferred embodiment, the sides of the flexible wiper/seals alternately wipe the inner wall of the shell in a continuous manner dependent on the direction of travel of the bulkhead follower. Bulk material is discharged into the shell between the convex forward surface of the bulkhead follower and the confronting concave forward wall of the shell through suitable fittings. Preferably, air under pressure is applied to the upright rear surface of the bulkhead follower to move the bulkhead follower toward the forward end wall of the shell to discharge the bulk material from the shell through suitable fittings.

### BRIEF DESCRIPTION OF THE DRAWINGS

FIG. 1 is a perspective view of a horizontal bulk material container embodying the present invention broken away to show a bulkhead follower and illustrated with a fragmentary showing of a frame therefor and further illustrated with a fragmentary showing of heating ducts thereof.

FIG. 2 is a fragmentary, front elevation view of the horizontal bulk material container shown in FIG. 1 broken away to illustrate the bulkhead follower and illustrated with a fragmentary showing of the frame therefor.

FIG. 3 is a fragmentary, diagrammatic illustration of a sight gauge assembly and associated fittings employed in the horizontal bulk material container shown in FIGS. 1 and 2.

FIG. 4 is a elevation view of the sight gauge shown in FIGS. 1-3 and broken away to illustrate a tension spring and cable therefor.

FIG. 5 is a front elevation view of a stiffener ring and spider support taken along line 5-5 of FIG. 2 for supporting bearings, spacers and wiper/seals mounted circumferentially about the bulkhead follower shown in FIGS. 1 and 2.

FIG. 6 is an enlarged horizontal sectional view of the bearings, spacers and wiper/seals supported by annular flange which is secured to the spider support shown in FIG. 5 for mounting circumferentially about the bulkhead follower shown in FIGS. 1 and 2.

FIG. 7 is a fragmentary, enlarged diagrammatic illustration of the wiper/seal flexure when the bulkhead follower moves in a forward direction.

FIG. 8 is a fragmentary, enlarged diagrammatic illustration of the wiper/seal flexure when the bulkhead follower moves rearwardly.

FIG. 9 is a front elevation view of a second stiffener ring, rearward bearing and spokes connecting the stiffener ring to the disc hub of the annular spider.

FIG. 10 is a horizontal sectional view of the second embodiment bulkhead follower having the rearward bearings mounted on a second annular spider.

FIG. 11 is an enlarged horizontal sectional view of the bearings, spacers and wiper/seals supported by the first and second annular flanges which are secured to the spider support shown in FIGS. 5 and 9.

### DETAILED DESCRIPTION OF THE PREFERRED EMBODIMENT

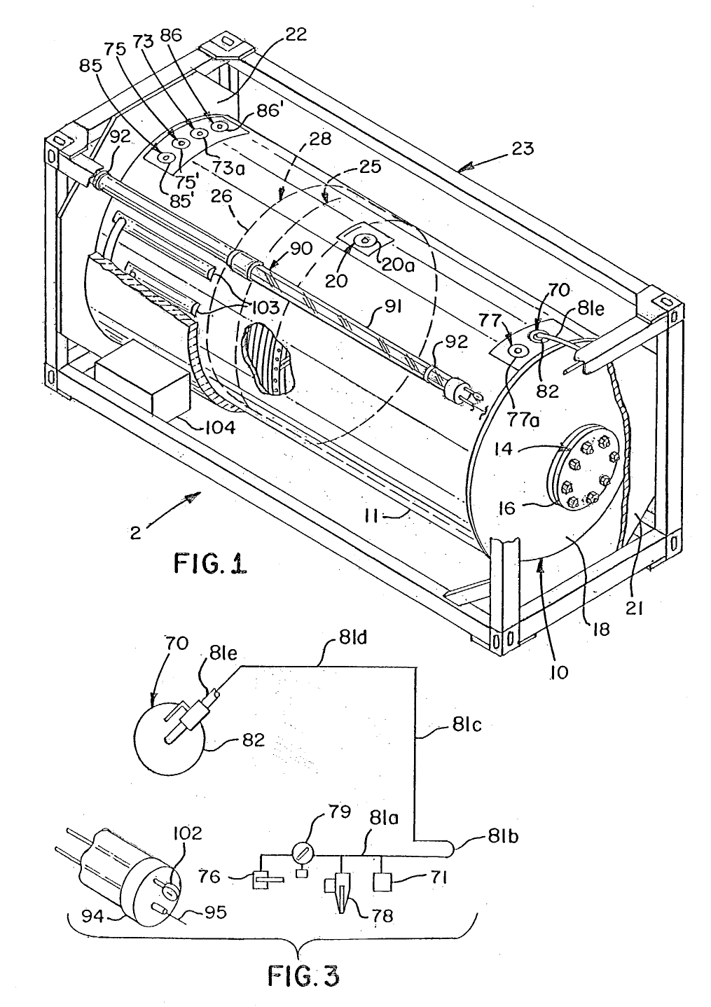

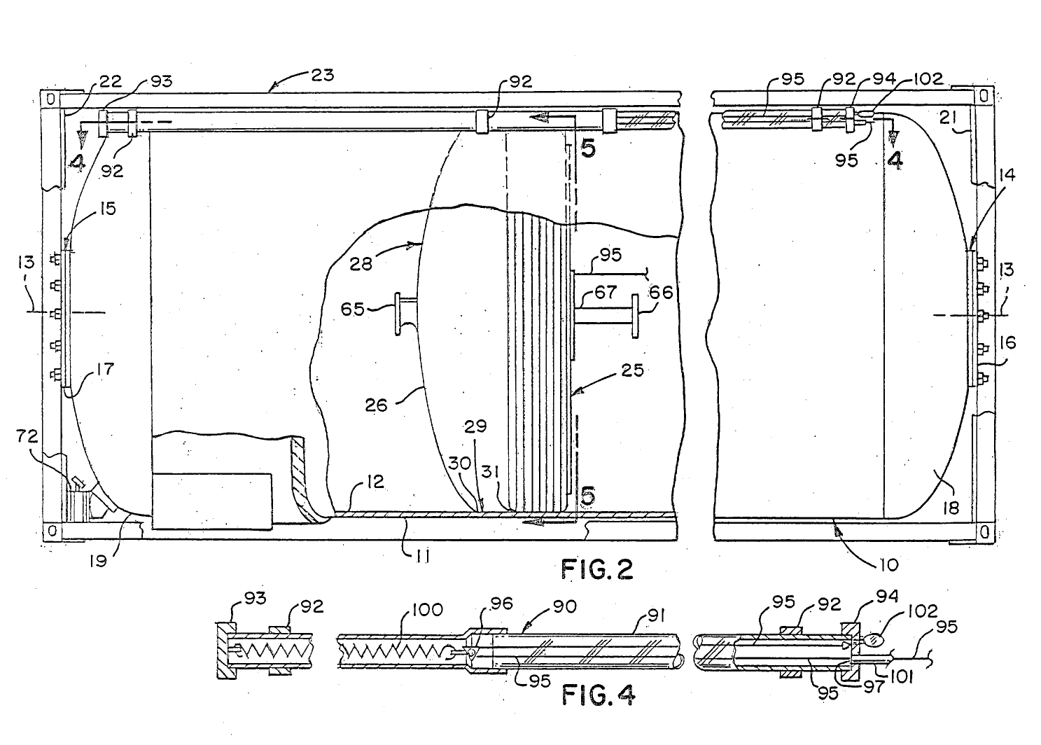

Illustrated in FIGS. 1 and 2 is a horizontal bulk material container 10 embodying the present invention for transporting, storing and discharging viscous bulk material. The container 10 includes a shell 11 having a horizontal/longitudinal axis 13 extending between a rear wall 18 and a forward wall 19 of the shell 11. Preferably, the shell 11 has a cylindrical inner wall 12. Preferably, both the inner and outer surfaces of the shell 11 are cylindrical. In the exemplary embodiment, the shell 11 is made of suitable material such as stainless steel. In the exemplary embodiment, the shell 11 is twenty feet from the rear wall 18 of the shell to the forward wall 19.

Further, the shell 11 is ninety inches in diameter, and the gross volumetric capacity of the shell 11 at the viscous material side is approximately forty-five hundred gallons. In the exemplary embodiment, the shell 11 has approximately a minimum volume of eight hundred and thirty-four gallons at the compressed air side.

At the opposite ends of the shell 11 are formed manholes 14 and 15. Suitable manhole covers 16 and 17 are removably secured to a rear wall 18 and a forward wall 19 of the shell 11, respectively, to cover the manholes 14 and 15, respectively by suitable means, such as nuts and bolts. The manholes 14 and 15 are large enough for an average size man to enter the shell 11. In the exemplary embodiment, each of the manholes 14 and 15 is approximately twenty-three inches in diameter. By virtue of the manholes 14 and 15 being located at the ends of the shell 11, the cylindrical inner wall 12 of the shell 11 is for the most part undisturbed. All activities may be performed through the manholes 14 and 15.

At the top of the shell 11 midway between the ends thereof is disposed a normally closed central port 20 (FIG. 1) which is opened to provide access to the interior of the shell 11. The central port 20 provides a multiple function port to gain access to the shell 11 for service and repair. With central port 20 placed as shown in FIG. 1, standard cleaning procedures can be carried out, and, also, a bulkhead follower 25 can be supported during maintenance operations. Central port 20 is a flanged outlet flush with the cylindrical inner wall 12 of the shell 11 so as not to restrict movement of the bulkhead follower 25. The outlet of central port 20 is closed by an externally bolted flange 20a affixed from the outside by four corner bolts.

The rear wall 18 of the shell 11 and the forward wall 19 of the shell 11 are attached to forward and rear barriers 21 and 22 which are attached to the conventional structural frame 23 containing the container 10. The frame conforms to ISO standards for shipping containers. The frame is provided with a catwalk (not shown) on top of the shell 11 and provided with appropriate fittings at its corners so it may be stacked with other containers and frames meeting ISO standards.

Disposed within the shell 11 is the bulkhead follower 25 (FIGS. 1 and 2). The bulkhead follower 25 has a circular shape when viewed face on. In the exemplary embodiment, the bulkhead follower 25 is a rigid follower and is made of stainless steel. Follower 25 could also be made from aluminum or synthetic resin. In the preferred embodiment, the axis 24 of the bulkhead follower 25 is coincident with the axis of the shell 11. The diameter of the bulkhead follower 25 is slightly less than the diameter of the shell 11 and is capable of traveling between the forward wall 19 and the rear wall 18 of the shell 11.

In the preferred embodiment, a forward surface 26 of the bulkhead follower 25 can be considered to have a generally convex configuration conforming to the generally concave inner surface of the forward wall 19 of the shell 11. In this manner, the emptying of the shell 11, is carried out more efficiently with minimum bulk material remaining in the shell 11 at the completion of the emptying procedure. Also, in the preferred embodiment, the rear surface 27 of the bulkhead follower 25, corresponding to the forward surface 26, has a generally concave configuration.

The bulkhead follower consists of a wall 28, preferably, the wall being formed with a concave forward surface 26 and a convex rear surface 27. In the preferred embodiment, the wall 28 is curved such that there is a gradual and smooth transition to a rim 29 at the outer perimeter of the wall 28. The rim 29 is cylindrical or substantially cylindrical.

The rim 29 is formed with a leading edge 30 and a trailing edge 31. The rim 29 connects to the wall 28 at its leading edge 30. The rim 29 represents the greatest diameter of the bulkhead follower 25. The rim 29 connects to an annular shoulder 32 at its trailing edge 31.

In the preferred embodiment, when the bulkhead follower 25 is disposed in the shell 11 with its axis 24 coincident with the axis 13 of the shell 11, the annular shoulder 32 is disposed perpendicular to the axes of the bulkhead follower 25 and the shell 11. The annular shoulder 32 extends inwardly towards the axis of the bulkhead follower 25 a selected distance. In the preferred embodiment, the annular shoulder 32 is formed with an outer circular edge 33 and an inner circular edge 34. The annular shoulder 32 connects to the rim 29 along its outer circular edge 33. The annular shoulder 32 connects to a annular flange 35 at its inner circular edge 34.

The annular flange 35 is a cylindrical wall that extends a selected distance. The cylindrical wall of the annular flange 35 extends along the axis 24 of the bulkhead follower 25, when the bulkhead follower 25 is disposed in the shell 11 with its axis 24 coincident with the axis 13 of the shell 11. The annular flange 35 is formed with a leading edge 36 and a trailing edge 37. The annular flange 35 connects to the annular shoulder 32 at its leading edge 36. In the preferred embodiment, the cylindrical wall of the annular flange 35 is spaced from the greatest diameter of the bulkhead follower 25, which occurs at the rim 29, a selected distance which corresponds to the annular shoulder 32. The annular flange 35 connects to a stiffener ring 38 at its trailing edge 37.

In the preferred embodiment, when the bulkhead follower 25 is disposed in the shell 11 with its axis 24 coincident with the axis 13 of the shell 11, the stiffener ring 38 is disposed perpendicular to the axes 24 and 13 of the bulkhead follower 25 and the shell 11. The stiffener ring 38 extends inwardly towards the axis 24 of the bulkhead follower 25 a selected distance. In the preferred embodiment, the stiffener ring is formed with an outer circular edge 39 and an inner circular edge 40. The stiffener ring 38 connects to the annular flange 35 along its outer circular edge 39. The stiffener ring 38 is preferably made of suitable material, such as stainless steel, as is the annular flange 35 and the annular shoulder 32.

Secured to the stiffener ring 38 by suitable means, such as nuts and bolts is a annular spider 41. The spider 41 includes a disc-shaped hub 42 and spokes 43 extending from the hub 42 to the stiffener ring 38. The distal ends of the spokes 43 are secured to the stiffener ring 38 by suitable means, such as nuts and bolts. The proximal ends of the spokes 43 are secured to the hub 42 by suitable means, such as nuts and bolts. In the exemplary embodiment, successive spokes 43 are spaced apart at an angle of forty-five degrees. The spider 41 helps maintains the rear cross-section of the bulkhead follower 25. The components of the spider 41 are also made of stainless steel.

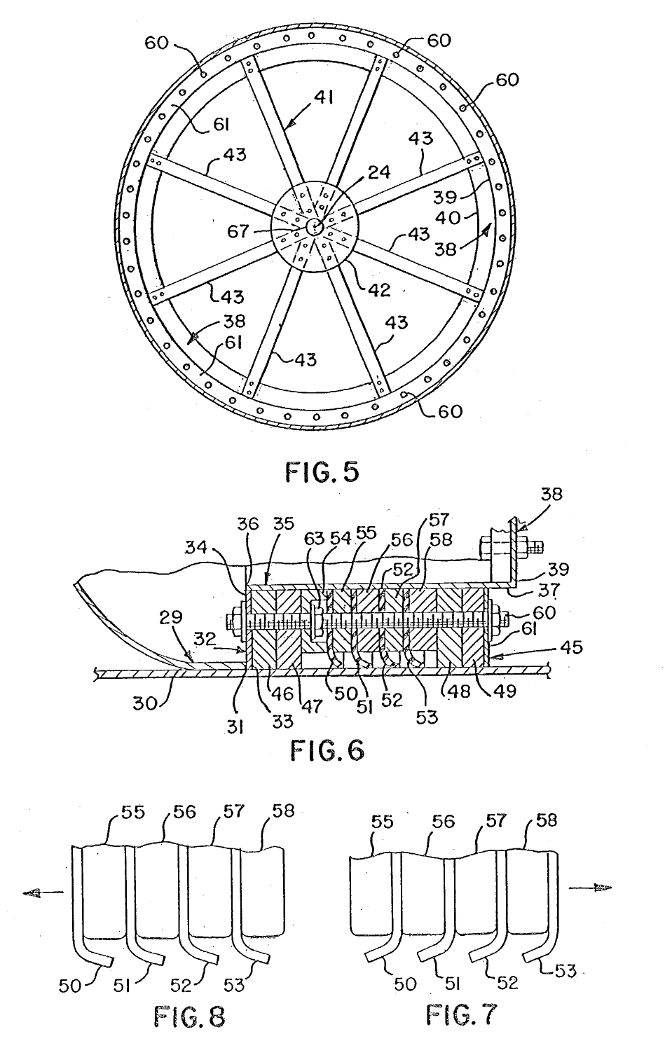

Mounted on the annular shoulder 32 and the annular flange 35 is an annular bearing, wiper/seal assembly 45 (FIG. 6). Included in the bearing, wiper/seal assembly 45 are suitable forward bearings 46 and 47, suitable rearward bearings 48 and 49, wiper/seals 50, 51, 52 and 53, and the spacers 54, 55, 56, 57 and 58. The forward bearings 46 and 47, the rearward bearings 48 and 49, the wiper/seals 50-53, and the spacers 54-58 have annular configurations and surround circumferentially the annular flange 35 of the bulkhead follower 25. The bearings 46-49 serve to limit the tilt and assist in the seal between the bulkhead follower 25 and the shell 11 by resisting tilting action to the bulkhead follower 25. The spider 41 supports the annular flange 35 which supports the bearings 46, 47, 48 and 49 which contact the shell 11 to maintain the stability of the bulkhead follower 25.

The bearings 46-49 are made from high density polyethylene. In the preferred embodiment, the bearings 46-49 are made-up of arcuate segments and are installed in bricklayer fashion to cover the 360 degree arc of the annular flange 35.

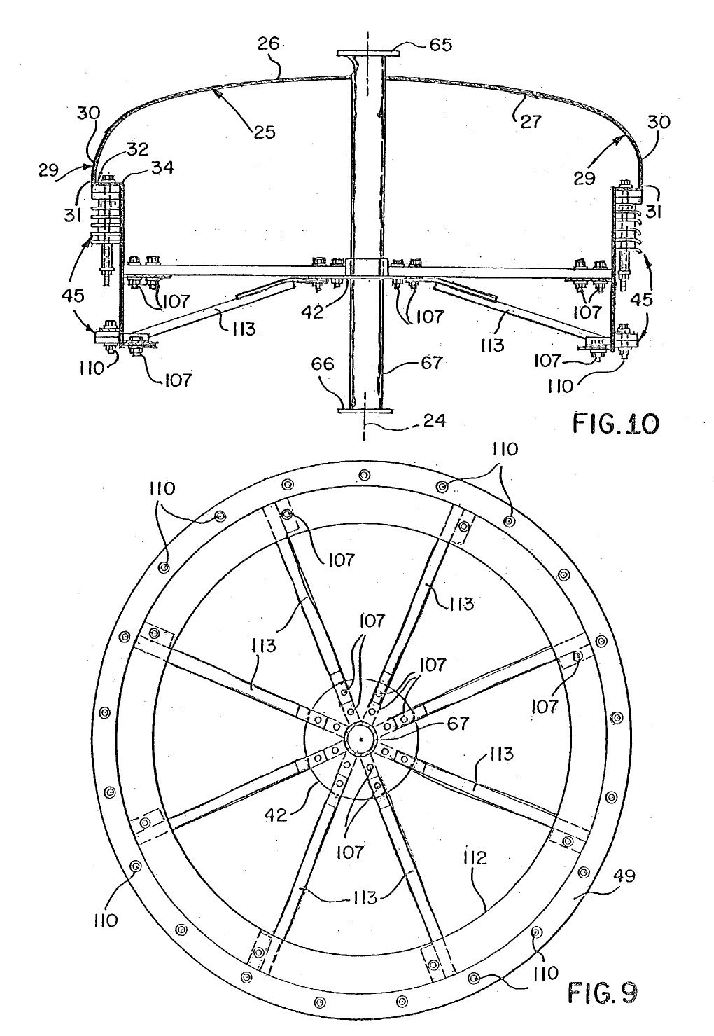

The wiper/seals 50-53 are flexible and are made of suitable material, such as neoprene or rubber. The sides of the wiper/seals 50-53 serve to seal the space between the outer surface of the bulkhead follower 25 and the inner surface of the shell 11 (FIGS. 1, 2, 6, 7, and 8). The sides of the respective flexible wiper/seals 50-53 alternately clean the inner surface of the shell 11 in a continuous manner dependent on the direction of travel of the bulkhead follower 25. When the bulkhead follower 25 moves toward the forward wall 19 of the shell 11, the respective wiper/seals 50-53 bend toward the rear wall 18 of the shell 11. Conversely, when the bulkhead follower 25 moves toward the rear wall 18 of the shell 11, the respective wiper/seals 50-53 bend toward the forward wall 19 of the shell 11.

The spacers 54-58 of the bearing, wiper/seal assembly 45 are not as tall as the wiper/seals 50-53 so as not to interfere with the flexing action of the wiper/seals 50-53. The edges of the spacers 54-58 are suitably curved to facilitate the alternate flexing of the wiper/seals 50-53 and reduce the wear and tear on the wiper/seals 50-53.

Threaded rods or mounting means 60 (FIG. 6) are inserted through and secured to the annular shoulder 32. In the preferred embodiment, successive rods or fasteners 60 are spaced apart at an angle of approximately 9 degrees. In the first embodiment, each rod 60 is received by radially spaced openings formed in the forward bearings 46 and 47, the wiper/seals 50-53, spacers 54-58, the rear bearings 48 and 49, and in a locking ring 61 at the end of the wiper/seal assembly 45. The forward bearings 46 and 47 are maintained in a fixed position on the rods 60 by the nuts on the rods 60 adjacent the annular shoulder 35 and a lock nut 63 in the spacer 58. The first nut can be welded to the annular shoulder 32. Preferably, the forward bearings are in contiguous relation with the forward surface 26 of the bulkhead follower 25. The wiper/seals 50-53, the spacers 54-57, and the rear bearings 48 and 49 are adjustably positioned on the rods 60 by the nuts adjacent to the locking ring 61.

The cylindrical configuration of the annular flange 35 of the bulkhead follower 25 is maintained by the spider 30. The spider 30 tends to distribute the load applied to the bulkhead follower 25 to compensate for an imbalance in the load resulting from any bending or leaning of the bulkhead follower 25 in its movement between the forward wall 19 and the rear wall 18 of the shell 11.

Extending forwardly from the forward surface 26 of the bulkhead follower 25 is a forward bumper 65 (FIG. 2) made of suitable material, such as stainless steel with a rubber surface. The bumper 65 dampens and absorbs the impact between the forward end of the bulkhead follower 25 and the manhole cover 17 of the forward wall 19 of the shell 11. The bumper 65 is secured to the forward surface 26 of the bulkhead follower 25 by suitable means, such as welding. A rear bumper 66 is mounted on a rod 67 that extends through the hub 42 of the spider 41 and abuts against the rear surface 27 of the bulkhead follower 25. The rear bumper 66 extends past the annular flange 35 of the bulkhead follower 25. The rear bumper 66 is made of suitable material, such as stainless steel with a rubber surface, and impacts the rear manhole cover 16 of the rear wall 18 of the shell 11.

To fill the shell 11 with bulk material, the bulkhead follower 25 is moved rearwardly toward the rear wall 18 of the shell 11. When the bulkhead follower 25 is moved toward the rear wall 18 of the shell 11, air within the shell 11 between the rear wall 18 of the shell 11 and the bulkhead follower 25 is vented through a port 70 (FIGS. 1, 3 and 4). The port 70 is, in the exemplary embodiment, disposed on the top of the shell 11 adjacent the rear wall 18 of the shell 11. Communicating with the port 70 is a suitable fitting, such as a manually actuated relief valve 71. During the movement of the bulkhead follower 25 toward the rear wall 18 of the shell 11, the manually actuated relief valve 71 is open for the air between the rear wall 18 of the shell 11 and the rear surface 27 of the bulkhead follower 25 to vent to atmosphere through the port 70 and the manually actuated relief valve 71.

The manual vent 71 is preferably a 1″ stainless steel reduced port ball valve as produced by Contech International, and is sold under the mark Voyager 2000.

For filling the shell 11 with bulk material between the forward wall 19 of the shell 11 and the forward surface 26 of the bulkhead follower 25, a suitable fitting, such as a ball valve 72 is actuated to an open position. The ball valve 72 is a 4″ butterfly valve, and is preferably manufactured by Fort Vale, model number 845/000A. The ball valve 72 is located at the lower center of the forward wall 19.

Bulk material could also be discharged into the shell 11 between the forward wall 19 of the shell 11 and the forward surface 26 of the bulkhead follower 25 through a port 75 (FIG. 1). The port 75 is formed in a flange 75′. After the bulk material is discharged into the shell 11 between the forward surface 26 of the bulkhead follower 25 and the forward wall 19 of the shell 11, the ball valve is closed. The section of the shell 11 between the forward wall 19 of the shell 11 and the forward surface 26 of the bulkhead follower 25 is deemed the viscous material side.

To remove the bulk material from the shell 11, the ball valve 72 is opened. Thereupon, air under pressure is introduced into the shell 11 through a manually actuated air input valve 76 that communicates with port 70 disposed between the rear wall 18 of the shell 11 and the rear surface 27 of the bulkhead follower 25 (FIG. 3). When the manually actuated air input valve 76 is opened, the manually actuated relief valve 71 is closed. Thereupon, air under pressure engages the rear surface 27 of the bulkhead follower 25 and moves the bulkhead follower 25 toward the forward wall 19 of the shell 11. With the ball valve 72 opened, bulk material is discharged from the shell 11 through the ball valve (FIG. 1). The section of the shell 11 between the rear surface 27 of the bulkhead follower 25 and the rear wall 18 of the shell 11 is deemed the compressed air side. The inventor has found that only a small pressure differential is necessary for moving the bulkhead follower 25 for the discharge of bulk material from the shell 11. In operation, the inventor has found that as little as 3 or 4 pounds of pressure on the viscous material side and 10 pounds on the compressed air side is sufficient to move certain materials. The bulkhead follower 25 can withstand a pressure differential between the viscous material and compressed air sides of 1.5 Bars. The outer shell 11 is designed to withstand internal pressures of 4 Bars.

Between port 70 and air input valve 76 there is placed a safety relief valve 78 (FIG. 1) for venting air under pressure to atmosphere when the air pressure in the shell 11 between the rear wall 18 thereof and the rear surface 27 of the bulkhead follower 25 exceeds the safe pressure. The air under excessive pressure is vented to atmosphere through the safety relief valve 78.

Air under excessive pressure is also vented to the atmosphere through the safety relief port 77 (FIG. 1). The port 77 is formed in a flange 77a and is fitted with a safety relief valve.

The inventor has found that safety relief valves can be 1″ pressure activated relief valves manufactured by Aquatrol, Model Number 88-20 PSI.

Between port 70 and air input valve 76 there is placed a regulator 79. Air pressure regulator 79 (FIG. 3) communicates with the air inlet valve 76 for maintaining a safe entry of air under pressure between the rear wall 18 of the shell 11 and the rear wall 27 of the bulkhead follower 25. Regulator 79 is preferably a 1″ back pressure relief regulator manufactured by Wilkerson, model number B38-08-FL00. The gauge for measuring pressure is manufactured by Ashcroft and is model number 35W1005PH02L30-0-30 PSI.

Thus, air under pressure enters the shell 11 between the rear wall 18 of the shell 11 and the rear surface 27 of the bulkhead follower 25 over a path including the air inlet valve 76, the regulator 79, conduits 81a-81e, and the port 70, covered by shell flange 82 (FIG. 3) for moving the bulkhead follower 25 toward the forward wall 19 of the shell 11. Such movement of the bulkhead follower 25 causes bulk material in the shell 11 between the forward surface 26 of the bulkhead follower and the forward wall 19 of the shell 11 to be discharged from the shell 11 through the opened ball valve.

Should the air pressure in the shell 11 become excessive, then the air under pressure is vented to atmosphere through the port 70, flange 82, conduits 81a-81d, and the safety relief valve 78 or port 77 and flange 77a.

At the top of the shell 11 is port 73 (FIG. 1) communicating with a suitable fitting, such as a rupture disc (not shown). The port 73 is formed in flange 73a. In the exemplary embodiment, the rupture disc is constructed to blow out at thirty pounds of internal pressure. In the preferred embodiment, the rupture disc is manufactured by Carbone of America, Chemical Equipment Division, part number Series 1-4″ Disc 30 PSI. The rupture disc is made of pheonolic impregnated graphite.

Disposed on the top of the shell 11 is a port 85 (FIG. 1). The port 85 is formed in a flange 85′. It is not used in the system. A capped port 86 formed in a flange 86′ can also be placed on the top of the shell 11 for communicating with an adjunctive pressure fitting, not shown.

For indicating the position of the bulkhead follower 25 along the horizontal axis of the shell 11, a sight gauge 90 is provided (FIGS. 2-4). The sight gauge 90 comprises a tube or a housing 91 made of suitable material, such as glass or plastic. In the exemplary embodiment, the end of the tube 91 associated with the rear section of the shell 11 is clear and the end of the tube 91 associated with the forward section of the shell 11 is opaque. The tube 91 is attached to a conventional frame 23 for the bulk material container 10 by suitable hangers 92. At the forward end of the tube 91 is an end cover 93 that closes one end of the tube 91. At the rear end of the tube 91 is an end cover 94 that has a suitable opening 97 through which passes the lower run of a cable 95.

The cable 95 is trained around a position indicator 96 for the gauge 90, which position indicator 96 moves generally axially within the tube 91. In the exemplary embodiment, the position indicator 96 is a pulley. The pulley is preferably brightly colored and its position in the tube 91 corresponds to the position of the follower 25 in the shell 11. The lower run of the cable 95 is received by an opening 97 in the end cover 94 and is attached to the hub 42 of the spider 41. The upper run of the cable 95 is anchored to the rear end flange 94. The extent of the lower run of the cable 95 varies in the axial direction with the axial movement of the bulkhead follower 25. The upper run of the cable 95 and the lower run of the cable 95 are trained around the pulley 96. The pulley 96 is attached to one end of a tension spring 100 by a swivel joint and is maintained under tension by the tension spring 100 and the axial movement of the bulkhead follower 25. The other end of the tension spring 100 is anchored to the forward end cover 93. Thus, as the bulkhead follower 25 moves within the shell 11, the pulley 96 moves therewith within the tube 91 to indicate the location of the bulkhead follower 25 within the shell 11. By looking through a clear section of the tube 91, an operator can observe the location of the pulley 96 and determine the location of the bulkhead follower 25 within the shell 11. The lower run of the cable 95 extending outside of the tube 91 passes through a sheath 101.

A gauge 102 is supported by the end cover 94 to indicate the air pressure within the shell 11 between the rear end 18 of the shell 11 and the rear wall 27 of the bulkhead follower 25. The sheath 101 which contains cable 95 penetrates shell 11, therefore, the air pressure inside the shell 11 between the rear wall 18 and the rear surface 27 of the follower 25 is maintained in tube 91. The gauge 102 penetrates the rear end cover 94 and directly reads the pressure in the tube 91.

Shell 11 is heated externally by heating ducts 103. The heating ducts 103 are channels welded to the outer surface of the shell 11. The heating ducts 103 are in communication with an electric heating system, a circulating pump, and temperature controls to actuate the electric heating system. Preferably, glycol is circulated in the heating ducts. The electric heating system, circulating pump and temperature controls are stored in housing 104. Power for the electric heating system, pump and temperature controls is provided by the transport vehicle or some other external source.

In the preferred embodiment, when the follower 25 is in its operating position, the rearward bearings 48 and 49, at any point along the circumference of the follower 25, are positioned a selected distance away from their axially aligned point on the leading edge 30 of the rim 29 (where the forward wall 28 of the follower 25 substantially approaches the diameter of the shell 11 when traveling along the forward wall 28 of the follower on a radius outward from the most forward point) such that the follower 25 cannot tip out of its alignment, allowing material to pass around the follower 25.

Also in the preferred embodiment, when the rearward bearings 48 and 49 are removed from the follower 25, the follower 25 is able to be tipped or rotated in the shell 11 so that the longitudinal axis 24 of the follower lies perpendicular to the longitudinal axis 13 of the shell 11. This makes servicing the wiper/seal assembly 45 relatively simple as the workman can stand over the wiper/seal assembly 45 as he works on it.

In the preferred embodiment, the forward bearings 46 and 47, wipers/seals 50-53 and rearward bearings 48 and 49 are mounted on elongated fasteners 60 disposed substantially parallel to the longitudinal axis 24 of the follower 25. Again, this makes servicing the wiper/seal assembly 45 relatively simple, since when the follower 25 is rotated so that its forward surface 26 faces downward in the shell 11 all of the elongated fasteners 60 lie substantially parallel to each other and project upwardly, where the service man can stand over them.

The spacers 54-58 are formed in arcs of selected radians, dependent on the size of the commercially available materials from which the spacers 54 and 58 are made. The segments that make up the spacers 54-58 are positioned in staggered fashion so that the joints between segments are not in alignment.

A plurality of wiper/seals 50-53 are used to better clean the inner surface 12 of the shell 11. The exact number of wiper/seals 50-53 used depends, in part, on the material to be carried by the shell 11.

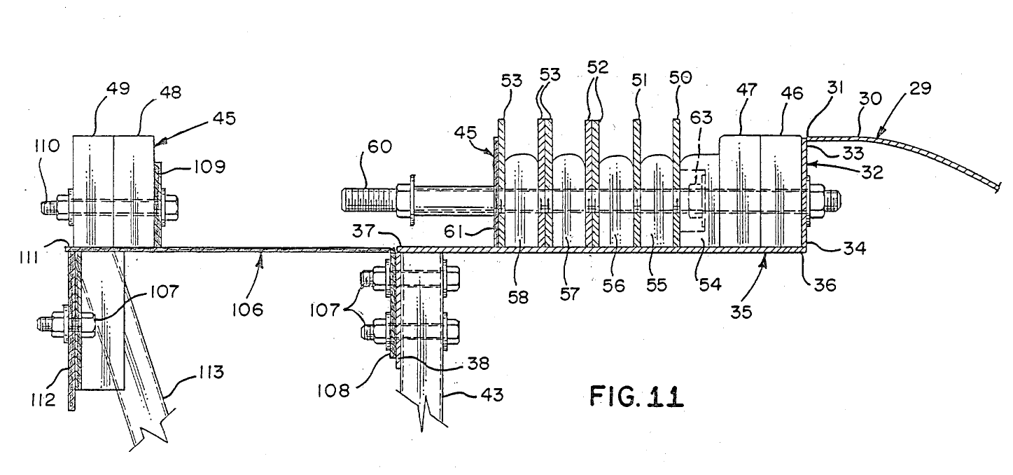

As shown in FIGS. 9, 10 and 11, also in the preferred embodiment, the rear bearings 48 and 49 are positioned on a separate, second annular flange 106. In the preferred embodiment, the second annular flange 106 can be separated from the annular flange 35 with the rear bearings 48 and 49 undisturbed. Preferably, the second annular flange 106 is connected to the annular flange by means of bolted connections 107 at the stiffener ring 38 and a connection ring 108 attached to the second annular flange 106.

The second annular flange 106 is formed with a second annular shoulder 109. A plurality of second threaded rods or fasteners 110 are secured to the second annular shoulder 109, and the rear bearings 48 and 49 of the preferred embodiment are mounted on the second threaded rods 110. As with the first annular flange, 35 the trailing edge 111 of the second annular flange 106 is connected to a second stiffener ring 112. The second stiffener ring 112 is in turn connected to a series of spokes 113 which are connected to the disc hub 42 of the annular spider 41, preferably by bolted connections 107.

In the preferred embodiment, when the seals 50-53 on the follower 25 need to be serviced, selected bolted connections 107 between the second annular flange 106 and the first annular flange 35 are undone, and the second annular flange 106 is slid toward the rear wall 18 of the shell 11. With the rear bearings 47 and 48 removed from the follower 25, the follower 25 can tip much more easily in the shell 11. When the follower is tipped inside the shell 11, it is preferable that the follower 25 is supported by a chain or chord run through the central port 20.

What is claimed is:

1. A bulk material container comprising:
(a) an elongated shell for containing and discharging bulk material, said shell having a generally cylindrical inner wall, said shell having a horizontal axis extending longitudinally between a forward end wall thereof and a rear end wall thereof;
(b) a manhole formed in said shell;
(c) a bulkhead follower movable within said shell between said forward end wall and said rear end wall of said shell, said bulkhead follower having a cylindrical annular flange slightly less in diameter than the cylindrical inner wall of said shell, said bulkhead follower having a horizontal axis substantially coincident with the horizontal axis of said shell; and
(d) at least one flexible wiper/seal circumferentially disposed about the circumference of the cylindrical annular flange of said bulkhead follower, said wiper/seal having oppositely directed sides, said oppositely directed sides of said wiper/seal alternately engage the inner wall of said shell to wipe and form a seal with said inner wall of said shell depending on the direction of movement of said bulkhead follower within said shell.

2. A bulk material container as claimed in claim 1 and comprising: an annular forward bearing disposed forwardly of said wiper/seal, said forward bearing being mounted circumferentially about the circumference of the cylindrical annular flange of said bulkhead follower forward of said wiper/seal.

3. A bulk material container as claimed in claim 2 and comprising: an annular rear bearing disposed rearwardly of said wiper/seal, said rear bearing being mounted circumferentially about the circumference of the cylindrical annular flange of said bulkhead follower rearward of said wiper/seal for limiting tilting of said bulkhead follower.

4. A bulk material container as claimed in claim 3 and comprising a plurality of said wiper/seals, and a plurality of annular spacers disposed circumferentially about the circumference of the cylindrical annular flange of said bulkhead follower, said spacers being disposed respectively adjacent the sides of said wiper/seals, said spacers having a diameter smaller than the diameter of the associate side of said wiper/seals to avoid interference with the flexing action of the associated wiper/seals.

5. A bulk material container as claimed in claim 4 wherein the edges of said spacers are curved to facilitate the alternate flexing of said wiper/seals.

6. A bulk material container as claimed in claim 1 and comprising: means for mounting said wiper/seal circumferentially about the circumference of the cylindrical annular flange of said bulkhead follower.

7. A bulk material container as claimed in claim 1 having a stiffener ring secured to said cylindrical annular flange of said follower and an annular spider secured to said stiffener ring.

8. A bulk material container as claimed in claim 3 wherein a stiffener ring is connected circumferentially to the cylindrical annular flange of said bulkhead follower, an annular spider is connected to said stiffener ring, said stiffener ring, said spider, and said rear bearing control the cylindrical configuration of the annular flange of said bulkhead follower for uniformly distributing the forces applied to said annular flange of said bulkhead follower resulting from bending distortion of the bulkhead follower in its forward movement in said shell.

9. A bulk material container comprising:
(a) an elongated shell for containing and discharging bulk material, said shell having a generally cylindrical inner wall, said shell having a longitudinal axis extending longitudinally between a forward end wall thereof and a rear end wall thereof;
(b) a manhole formed in said shell;
(c) a bulkhead follower movable within said shell between said forward end wall and said rear end wall of said shell, said bulkhead follower having a substantially cylindrical annular flange slightly less in diameter than the cylindrical inner wall of said shell, said bulkhead follower having a horizontal axis substantially coincident with the longitudinal axis of said shell;
(d) means interengaging the annular flange of said bulkhead follower and the cylindrical inner wall of said shell for forming a seal therebetween;
(e) a bulk material discharge outlet in the vicinity of the forward end wall of said shell for the discharge of bulk material contained in said shell between the forward wall of said bulkhead follower and the forward end wall of said shell;
(f) means for introducing fluid under pressure into said shell between the rear end wall of said shell and the rear surface of said bulkhead follower for applying fluid under pressure to the rear surface of said bulkhead follower to move said bulkhead follower toward said forward end wall of said shell and moving said bulkhead follower along its horizontal axis and along the longitudinal axis of said shell for discharging bulk material within said shell between the forward end wall of said shell and the forward surface of said bulkhead follower through said bulk material discharge outlet; and
(g) a sight gauge mounted adjacent to and exterior of said shell responsive to the axial horizontal movement of said bulkhead follower along the longitudinal axis of said shell for indicating the location of said movable bulkhead follower along the longitudinal axis of said shell.

10. A bulk material container as claimed in claim 9 wherein said gauge comprises a bulkhead follower position indicator under tension at one end thereof and at the other end thereof connected to said bulkhead follower to indicate the position of said bulkhead follower along the longitudinal axis of said shell.

11. A bulk material container as claimed in claim 10 wherein said bulkhead position indicator is a pulley.

12. A bulk material container as claimed in claim 9 wherein said gauge comprises a housing, said housing having a horizontal axis generally parallel to the longitudinal axis of said shell, said bulkhead follower position indicator being disposed in said housing and movable along the horizontal axis of said housing to indicate the position of said bulkhead follower along the longitudinal axis of said shell.

13. A bulk material container as claimed in claim 9 wherein said gauge comprises:
(1) a housing with a horizontal axis generally parallel to the horizontal axis of said bulkhead follower, said housing having a cover at one end thereof,
(2) a pulley disposed in said housing for indicating the location of said bulkhead follower along the axis of said shell,
(3) a cable having a first and second run trained around said pulley, said first run of said cable being attached to said bulkhead follower for movement therewith as said bulkhead follower moves along the longitudinal axis of said shell toward the forward end wall of said shell, and
(4) a tension spring anchored at one end thereof to said cover of said housing and at the other end thereof said tension spring being attached to said pulley,
(5) said pulley being movable along a horizontal path parallel to the horizontal axis of said bulkhead follower and against the tension force of said tension spring to indicate the location of said bulkhead follower along the longitudinal axis of said shell.

14. A bulk material container as claimed in claim 13 wherein said pulley is attached to said tension spring for swivel movement.

15. A bulk material container as claimed in claim 3, wherein midway between the ends of said shell a normally closed central port is disposed.

16. A bulk material container as claimed in claim 3, wherein said wiper/seal creates a full 360 degree seal and each of said forward and rearward bearings are sectional and laminated to provide 360 degrees of bearing surface.

17. A bulk material container as claimed in claim 3, wherein said arrangement of wiper/seals is adjustable for seals of varying dimensions through the placement of the sectional spacers and a plurality of fasteners that provide clamping action.

18. A bulk material container comprising:
(a) an elongated shell for containing and discharging bulk material, said shell having a generally cylindrical inner wall, said shell having a horizontal axis extending longitudinally between a forward end wall thereof and a rear end wall thereof;
(b) a manhole formed in said shell, allowing access to the interior of the shell;
(c) a bulkhead follower movable within said shell between said forward end wall and said rear end wall of said shell, said bulkhead follower having an annular flange of slightly less diameter than the cylindrical inner wall of said shell, said bulkhead follower having a horizontal/longitudinal axis substantially coincident with the horizontal/longitudinal axis of said shell; and
(d) at least one flexible wiper/seal circumferentially disposed about the circumference of the annular flange of said bulkhead follower, said wiper/seal being connected to said bulkhead follower by fasteners substantially aligned with said horizontal/longitudinal axis of said follower.

19. A bulk material container as claimed in claim 18 and comprising: an annular forward bearing disposed forwardly of said wiper/seal, said forward bearing being mounted circumferentially about the circumference of the cylindrical annular flange of said bulkhead follower forward of said wiper/seal.

20. A bulk material container as claimed in claim 19 and comprising: an annular rear bearing disposed rearwardly of said wiper/seal, said rear bearing being mounted circumferentially about the circumference of the cylindrical annular flange of said bulkhead follower rearward of said wiper/seal for limiting tilting of said bulkhead follower.

21. A bulk material container as claimed in claim 20 and comprising a plurality of said wiper/seals, and a plurality of annular spacers disposed circumferentially about the circumference of the cylindrical annular flange of said bulkhead follower, said spacers being disposed respectively adjacent the sides of said wiper/seals, said spacers having a diameter smaller than the diameter of the associate side of said wiper/seals to avoid interference with the flexing action of the associated wiper/seals.

22. A bulk material container as claimed in claim 18 comprising:
(a) a stiffener ring secured to said cylindrical annular flange of said follower;
(b) and an annular spider secured to said stiffener ring.

23. A bulk material container as claimed in claim 20, wherein: the rear bearings are positioned on a second annular flange which can be separated from the annular flange with the rear bearings undisturbed.

24. A bulk material container as claimed in claim 23, wherein: said second annular flanges is formed with a second annular shoulder, and a plurality of second threaded rods are secured to the second annular shoulder, and the rear bearings of the preferred embodiment are mounted on the second threaded rods.

25. A bulk material container as claimed in claim 24, wherein: said second annular flange is formed with a trailing edge, and a stiffener ring is connected to said second annular flange at said trailing edge.

26. A bulk material container as claimed in claim 25, wherein: said second stiffener ring is connected to a series of spokes which are connected to the disc hub of the annular spider.

27. A bulk material container comprising:
(a) an elongated shell for containing and discharging bulk material, said shell having a generally cylindrical inner wall, said shell having a horizontal axis extending longitudinally between a forward end wall thereof and a rear end wall thereof;
(b) a manhole formed said shell;
(c) a bulkhead follower movable within said shell between said forward end wall and said rear end wall of said shell, said bulkhead follower having a cylindrical annular flange slightly less in diameter than the cylindrical inner wall of said shell, said bulkhead follower having a horizontal axis substantially coincident with the horizontal axis of said shell; and
(d) at least one flexible wiper/seal circumferentially disposed about the circumference of the cylindrical annular flange of said bulkhead follower, said wiper/seal having oppositely directed sides, said oppositely directed sides of said wiper/seal alternately engage the inner wall of said shell to wipe and form a seal with said inner wall of said shell depending on the direction of movement of said bulkhead follower within said shell.
